(19) United States
(12) Patent Application Publication
(10) Pub. No.: US 2021/0342870 A1
(43) Pub. Date: Nov. 4, 2021

(54) SOURCE CODE TRADING SYSTEM USING AI

(71) Applicant: ONE ACT INC., Tokyo (JP)

(72) Inventor: Yusuke ASANO, Tokyo (JP)

(21) Appl. No.: 17/340,673

(22) Filed: Jun. 7, 2021

Related U.S. Application Data
(63) Continuation of application No. PCT/JP2019/048045, filed on Dec. 9, 2019.

(30) Foreign Application Priority Data
Dec. 10, 2018 (JP) 2018-230575

(51) Int. Cl. G06Q 30/02; G06Q 20/12; G06F 8/75

(52) U.S. Cl. CPC G06Q 30/0206; G06F 8/75; G06Q 20/123

(57) ABSTRACT

Provided is: a mechanism for allocating trading profits based on the similarity of source codes; or a mechanism for dynamic pricing (variable price) using information from external sources. Provided is a source code trading system for buying and selling a source code of a software, the source code trading system comprising: a storing means for storing the source code; a price determining means for calculating a first sales price of the source code based on at least one of a content of the source code, a buying and selling information, and a bibliographic information; an external information acquiring means for acquiring an information from an external service server located outside the source code trading system; a price adjusting means for adjusting the first sales price based on the information obtained from the external service server and calculating a second sales price; and a demand-supply balance controlling means for displaying the calculated second sales price.

### TECHNICAL FIELD

### Related Application

This application claims priority to Japanese Patent Application No. 2018-230575 entitled “SOURCE CODE TRADING SYSTEM USING AI” filed on Dec. 10, 2018, the disclosure of which is hereby incorporated by reference in its entirety herein.

The present invention relates generally to source code trading systems for mediating buying and selling of source code of a computer program.

### Background Art

Trading systems for mediating buying and selling of various kinds of products are known. There are many trading systems that have the function of adjusting prices between sellers and buyers. To perform price adjustments, it is feasible to derive a reasonable price based on supply-demand relationships between a desired quantity to be sold and a desired quantity to be purchased.

In a case that the products to be sold are data which can be copied, the desired quantity to be sold may not be determined in many cases. This is because there is no limit on the quantity to be sold resulting from the production capacity, since the products can be produced by copying without necessity to produce the products. Assuming that the desired quantity to be sold is infinite (or a sufficiently large number), the price derived from the supply-demand relationship may become smaller than the value of the product.

Patent Literature 1 disclosed a price determination system for determining a price based on actually generated sales prices regarding purchase target data. The price is able to be determined based on the judgment of the buyer (demand side) so that the price can be set to reflect the value of the data as the product.

The method disclosed in Patent Literature 1 may also be used when the product is a source code of a computer program (hereinafter, simply referred to as “source code”). However, the method is not designed to perceive internal components of the product itself as the source code and external elements such as external services so that it may not be able to obtain a price which can sufficiently reflect the value of the source code as a product.

### CITATION LIST

### Patent Literature

[Patent Literature 1] JP2012-208946A

### SUMMARY OF THE INVENTION

### Technical Problem

The object of the present invention is to provide a source code trading system capable of mediating buying and selling of a source code at a price reflecting a value of the source code as a product.

Therefore, the present invention provides a mechanism for distributing profits due to buying and selling based on a similarity level of the source code and a mechanism for dynamic pricing (fluctuating prices) by using an information of external sources.

### Solution to Problem

In order to solve the above-mentioned problems, for example, a configuration described in the claims can be adopted.

Although the present application contains a plurality of means for solving the above-mentioned problems, one example to be disclosed is a source code trading system for buying and selling a source code of a software, the source code trading system comprising: a storing means for storing the source code; a price determining means for calculating a first sales price of the source code based on at least one of a content of the source code, a buying and selling information, and a bibliographic information; an external information acquiring means for acquiring an information from an external service server located outside the source code trading system; a price adjusting means for adjusting the first sales price based on the information obtained from the external service server and calculating a second sales price; and a demand-supply balance controlling means for displaying the calculated second sales price.

### Advantageous Effects of Invention

According to the present invention, it is possible to provide a mechanism for distributing profits due to buying and selling based on a similarity level of source code, and a mechanism for dynamic pricing (fluctuating prices) by using an information of external sources.

### BRIEF DESCRIPTION OF DRAWINGS

FIG. 1 is a diagram illustrating an example of a configuration of a source code trading system.

FIG. 2 is a diagram illustrating an example of a table of the price determination data.

FIG. 3 is a diagram illustrating an example of a flowchart of a calculation conducted by the price determination unit 15.

FIG. 4 is a diagram illustrating an example of a configuration of an overall system 400 which includes the source code trading system 1

FIG. 5 is a diagram illustrating an example of a hardware configuration of the source code trading system 1.

FIG. 6 is a diagram illustrating an example of a connection relationship of the entire system 400 which includes the source code trading system 1.

FIG. 7 is a diagram illustrating an example of a configuration example of the price data 18.

FIG. 8 is a diagram illustrating an example of a flowchart 800 of a method adapted to determine a similarity level.

FIG. 9 is a diagram illustrating an example of a flowchart 900 of a method adapted to determine a reference distribution rate.

FIG. 10 is a diagram illustrating an example of a flowchart 1000 of a method adapted to determine a reference distribution rate by using functional blocks.

FIG. 11 is a diagram illustrating an example of a flowchart 1100 of a method adapted to determine a price.

FIG. 12 is a diagram illustrating an example of a flowchart 1200 of a method adapted to calculate a predicted price.

FIG. 13 is a diagram illustrating an example of a flowchart 1300 of a method adapted to classify a source code by using a classifier.

FIG. 14 is a diagram illustrating an example of a flowchart 1400 of a method adapted to adjust a price by using external information.

FIG. 15 is a diagram illustrating an example of a flowchart 1500 of a method adapted to adjust a price based on information of news site.

FIG. 16 is a diagram illustrating an example of a flowchart 1600 of a method adapted to change an execution frequency of price adjustments based on external information.

FIG. 17 is an example of a Web screen 1700.

FIG. 18 is an example of a smartphone screen 1800.

### DESCRIPTION OF EMBODIMENTS

Embodiments of the present invention will be described below.

### 1^{st} Embodiment

### (Configuration of System)

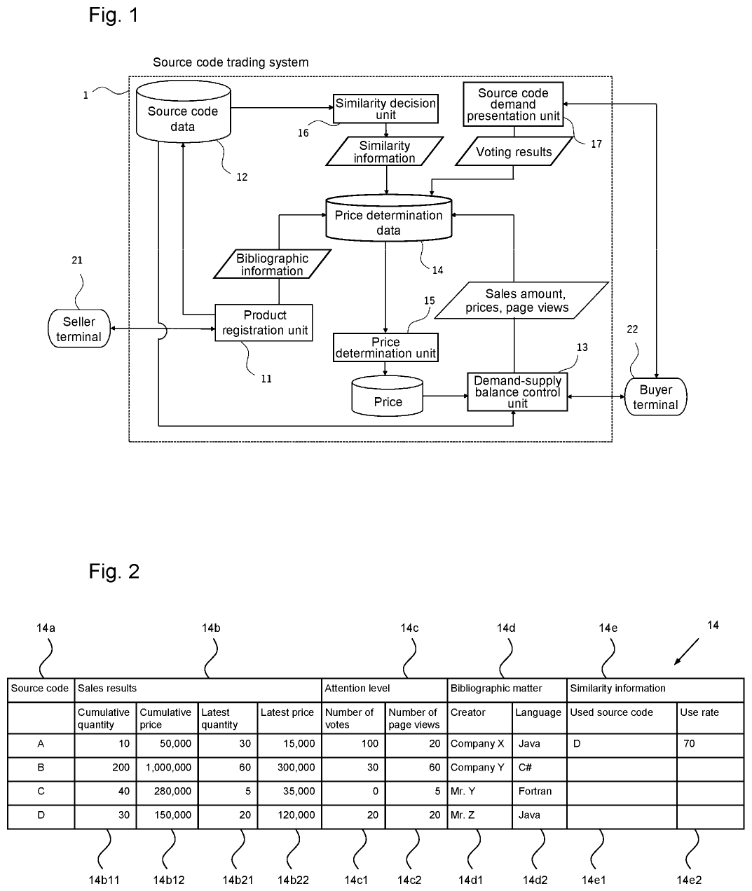

Referring to FIG. 1, therein is illustrated a configuration of a source code trading system. The source code trading system 1 is connected to one or more of seller terminal(s) 21 and one or more of buyer terminal(s) 22 via a network. The source code trading system 1 is configured to download and sell a source code data 12 registered from the seller terminal 21 via product registration unit 11 to a user of the buyer terminal 22 via a demand-supply balance control unit 13. The sales system does not have to be the downloading system.

The source code trading system 1 includes the product registration unit 11, the demand-supply balance control unit 13, a price determination unit 15, a similarity decision unit 16, and a source code demand presentation unit 17. The source code trading system 1 maintains a source code data 12 and a price determination data 14 therein.

The product registration unit 11 receives an information relating to a source code desired to be sold, from the seller terminal 21. The product registration unit 11 uploads and stores the source code desired to be sold as the source code data 12. The product registration unit 11 receives a bibliographic matter 14d which will be described below and uploads the price determination data 14.

The source code data 12 is a source code which is offered for sale.

The demand-supply balance control unit 13 displays an information including the source code to be sold and the price to the buyer terminal 22. Then, the demand-supply balance control unit 13 receives a purchase application from the buyer terminal so as to make the source code to be downloaded. Once the source code is purchased, the demand-supply balance control unit 13 uploads the price determination data 14 with regards to the sales results 14b which will be described below.

The demand-supply balance control unit 13 also includes a link to a home page which displays details of each source code. When the details are displayed by the link, the price determination data 14 is updated with regards to an attention level 14c which will be described below.

The price determination data 14 is a data for determining a price of each source code. The details will be described below.

The price determination unit 15 determines and holds the price of each source code based on the price determination data 14. The price maintained by the price determination unit 15 is used by the demand-supply balance control unit 13.

The similarity decision unit 16 calculates a similarity level of two source codes so as to infer that one of them has been created by using the other. When the similarity level is sufficiently large, the similarity decision unit 16 makes a judgment that they are similar (one has been created by using the other) and updates the price determination data 14 with regards to a similarity information 14e which will be described below.

Here, any type of method for calculating the similarity level may be used. For example, it is feasible to divide the source code line by line so as to determine a ratio of lines of identical contents. Also, it is feasible to determine a matching degree of variable names contained in the source codes. Furthermore, it is feasible to use other methods. For the present invention, it will be enough if the similarity determination is performed.

The source code demand presentation unit 17 receives a request for creating a source code (such as a function of a source code desired to be created or the like) from the buyer terminal 22 and displays a list of the received requests on the buyer terminal 22 (there may be a plurality of buyer terminals 22 which include other buyer terminals 22 except for the buyer terminal 22 having entered a demand for creating the source code). When displaying it, the source code demand presentation unit 17 provides a means of voting for showing an approval to create the source code by himself/herself (e.g., a like button or a recommend button). When the vote is made, the price determination data 14 is updated with respect to an attention level 14c which will be described below.

The source code demand presentation unit 17 also displays a list of accepted demands on the seller terminal 21 (in a case that the source code trading system 1 is operated as a home page of the Internet, a special mechanism for displaying the list on the seller terminal 21 may not be required because the same terminal may be the seller terminal 21 and the buyer terminal 22). In doing so, the number of votes shall also be indicated. The seller may obtain an information on the source code which is highly demanded for creating so as to progress with that development.

Referring to FIG. 2, therein is illustrated a table of the price determination data. The price determination data 14 includes a source code ID 14a, sales results 14b, an attention level 14c, a bibliographic matter 14d, and a similarity information 14e for each source code (for one line in the table).

The source code ID 14a is an identification (ID) for uniquely identifying each source code.

The sales results 14b correspond to a data including a quantity of sales and a sales price. The sales results 14b includes a cumulative quantity of sales since launch (accumulated quantity) 14b11 and a sales price (cumulative price) 14b12, as well as a quantity of sales within a predetermined later period of time (latest quantity) 14b21 and a sales price (latest price) 14b22. It is feasible to include only one of the cumulative quantity 14b11 and the cumulative price 14b12, or only one of the latest quantity 14b21 and the latest price 14b22.

In order to determine the latest quantity 14b21 and the latest price 14b22, it is feasible to receive the quantity of sales and the sales price from the demand-supply balance control unit 13 at the time of the sale and accumulate them for only a predetermined latest period based on the time of the sale. Alternatively, in a case that the latest quantity 14b21 and the latest price 14b22 are obtained for each daily period, it is feasible to set the value of the latest quantity 14b21 and the latest price 14b22 to 0 at the start of the period, and accumulate the quantity of sales and the sales price which are received from the demand-supply balance control unit 13.

The attention level 14c is a data indicating a degree of attention (degree of interest) of each source code. The attention level 14c includes a number of votes 14c1 received from the source code demand presentation unit 17 and a number of page views 14c2 received from the demand-supply balance control unit 13. The number of votes 14c1 and the number of page views 14c2 may also be an accumulated number, a latest number, or both in the same manner as the sales results 14b.

The bibliographic matter 14d is a data of bibliographic information received from the product registration unit 11. The bibliographic matter 14d includes a data of a creator 14d1 and a language 14d2.

The similarity information 14e is a data of similarity level received from the similarity decision unit 16. The similarity information 14e includes a data of a used source code 14e1 and a use rate 14e2. According to the FIG. 2, the source code D is created by using a source code A for 70% of it.

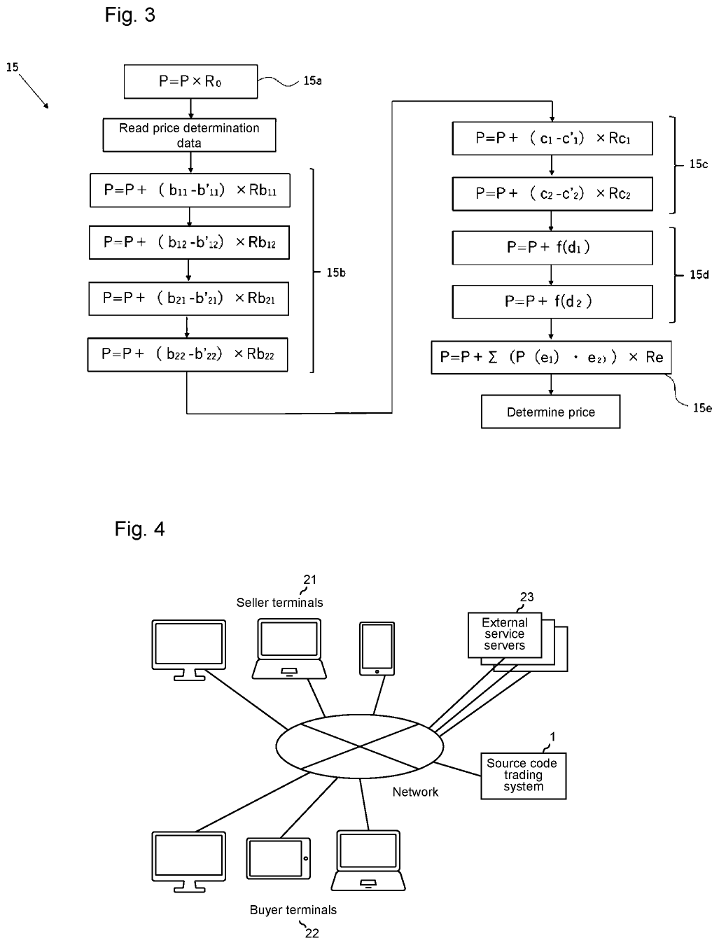

Referring to FIG. 3, therein is illustrated a flowchart of an example of a calculation conducted by the price determination unit. The price determination unit 15 may be activated to calculate a price of each source code once every day. The activation interval may be longer than one day, for example, three days, or one week, etc.

In addition, the activation interval may be shorter than one day, for example, 6 hours. However, in a case that the latest quantity 14b21 and the latest price 14b22 are adjusted to the activation interval of the price determination unit 15, there is a possibility that the time may fluctuate greatly between day and night. In this regard, when performing a processing of purchasing source codes from around the world, the fluctuations may be mitigated, so that it becomes feasible to frequently revise prices at intervals shorter than one day.

The price determining unit 15 multiplies the price (P) by R0 to reduce the amount (0<R0<1) in step 15a. Thereafter, it reads the price determination data 14 so as to adjust the price based on it. In a case that the price does not rise from the adjustments based on the price determination data 14, the price of the source code will fall with the lapse of time (i.e., the number of operations of the price determination unit 15). When a cause of a rise in the price is generated, the fall in the price will be stopped. As a result, the price will converge to a price that matches the value of the source code as a product, as a price that balances the fall in the price due to the passage of time with the occurrence of a factor that raises the price per unit of time.

When the adjustments based on the price determination data are made 14, adjustments based on the sales results (step 15b), adjustments based on the attention level (step 15c), adjustments based on the bibliographic matter (step 15d), and adjustments based on the similarity information (step 15e) are performed.

When the adjustments based on the sales results are made (step 15b), the prices are adjusted based on the sales results 14b (the cumulative quantity 14b11, the cumulative price 14b12, the latest quantity 14b21, and the latest price 14b22).

For example, with regards to the cumulative quantity 14b11, the reference value b′ 11 is subtracted from the value b11, and its result is multiplied by a predetermined ratio Rb11. Its result is added to the price P. In a case that b11 is bigger that b′ 11 (b11>b′11), the price will rise. On the other hand, in a case that b11 is smaller than b′11 (b11<b′11), the price will fall. (Hereinafter, the value included in the price determination data 14 is indicated by a symbol following “14” in the price determination data 14 (for example, b11 indicates a value of cumulative quantity which is indicated by a symbol of 14b11), and a ratio thereof is indicated by a symbol following “R”).

A similar calculation is performed for the cumulative price 14b12, the latest quantity 14b21, and the latest price 14b22. Accordingly, the price adjustments based on the sales results 14b are performed. It is feasible to perform the price adjustments for a part of the cumulative quantity 14b11, the cumulative price 14b12, the latest quantity 14b21, and the latest price 14b22 without performing the price adjustments for all of them. For example, it is feasible to perform the price adjustments only for the latest quantity 14b21 and the latest price 14b22. In this case, only latest sales results will be reflected to correspond to changes in demand.

The equation “P=P+(b11−b′11)×Rb11” is an exemplary for illustrating the price adjustments. It is feasible to perform the price adjustments based on any other equations.

Thus far, the price adjustments based on the sales results 14b (the cumulative quantity 14b11, the cumulative price 14b12, the latest quantity 14b22, and the latest price 14b22) are illustrated. However, the specific content thereof is illustrated as one example. It may be constructed in an any optional design.

When the adjustments based on the attention level are made (step 15c), the price is adjusted based on the attention level 14c (the number of votes 14c1 and the number of page views 14c2). The mathematical formula may be the same as the adjustments based on the sales results (step 15b).

When the adjustments based on the bibliographic matter are made (step 15d), the price is adjusted based on the bibliographic matter 14d (the creator 14d1 and the language 14d2). The bibliographic matter 14d is not a numeric value. Therefore, a function f for converting the bibliographic matter 14d to a numeric value is used.

The specific content of the function f may be defined as a design matter. For example, the value for each of the creator 14d1 and the language 14d2 may be determined by a manager of the source code trading system 1. Alternatively, the calculation may be performed based on the sales results 14b of other source codes which are for the same creator 14d1 and the same language 14d2.

When the adjustments based on the similarity information are made (step 15e), the price is adjusted based on the similarity information 14e (the used source code 14e1 and the use rate 14e2). In a case that another source code (used source code 14e1) which uses the source code exists for each source code, the value obtained by multiplying the use rate e2 of the price P(e1) of the other source code to be used becomes the basis for estimating the value of the source code. The results are multiplied by a predetermined ratio Re and the results are added to the price P. In a case that a plurality of other source codes to be used can exist, Σ is calculated to be added for all other source codes to be used.

The equation “P=P+(Σ(P(e1)·e2)×Re” is an example for illustrating the method of price adjustments. Note that it is feasible to adjust the prices by using any other equations.

As mentioned above, the source code trading system 1 of the present embodiment includes the price determination unit 15 which determines the price based on the price determination data 14. By using the sales results 14b, the attention level 14c, the bibliographic matter 14d, and the similarity information 14e as the price determination data 14, it is feasible to set the price to reflect the value of the source code.

It is feasible to maintain other information in the price determination data 14 and process them in the price determination unit 15 so as to set the price to reflect the value of the source code more accurately. A number of registrations of “favorites” on the homepage which displays details of the source code, an evaluation value when any evaluation of the source code is requested, a number of claims, and the like can be used as other information.

### 2^{nd} Embodiment

In the present embodiment, an example of a configuration for distributing the sales profit based on the similarity level of the source code will be described.

Referring to FIG. 4 therein is illustrated an example of a configuration of an overall system 400 which includes the source code trading system 1.

The overall system 400 includes a plurality of source code seller terminals 21, a plurality of source code buyer terminals 22, a plurality of external service servers 23, and the source code trading system 1. Each of the terminals and the servers are connected to the source code trading system 1 via a network. The network may be wired or wireless.

The seller terminal 21 may be, for example, a terminal such as a computer or tablet which is used by a software development company, a system construction company, an educational institute such as a university, a personal programmer, or the like. The seller terminal 21 may provide and sell a source code which is a software created by itself or a software improved by using other software(s).

The buyer terminal 22 may be a terminal such as a computer or tablet which is used by, for example, a software development company, a system construction company, an educational institution such as a university, a personal programmer, or the like. The buyer terminal 22 may purchase a source code of a software to be sold.

The source code trading system 1 connects the seller terminal 21 and the buyer terminal 22 so as to perform mediation for selling the source code at an appropriate price.

The external service server 23 may be, for example, a code trading site for buying and selling source codes similarly to the present source code trading system 1, a search engine site, a news site for providing news and stock prices, or the like. The source code trading system 1 acquires a sales price information related to the source code as well as an external information such as a news article information and a stock price information related to the source code, from the external service servers 23.

Each of the terminals of the overall system 400 and the source code trading system 1 may be, for example, a portable terminal such as a smart phone, a tablet, a mobile phone, or a personal digital assistant (PDA), or may be a wearable terminal such as a glasses type, a wrist watch type, or a clothing type. It may also be a stationary or portable computer, or a server located on a cloud or network. Alternatively, it may also be a combination of a plurality of these terminals. For example, it is feasible to use a combination of one smartphone and one wearable terminal logically as a single terminal. Furthermore, it is feasible to use an information processing terminal other than these types.

Each terminal of the entire system 400 or the source code trading system 1 includes a processor for executing an operating system, an application, a program, or the like; a main storage device such as a RAM (Random Access Memory) or the like; an auxiliary storage device such as an IC card, a hard disk drive, an SSD (Solid State Drive), a flash memory, or the like; a communication control unit such as a network card, a wireless communication module, a mobile communication module, or the like; an input device such as a touch panel, a keyboard, a mouse, a voice input, a motion detection unit using of captured images of the camera unit, or the like; and an output device such as a monitor or a display. Note that the output device may be a device or a terminal for transmitting information to be output to an external monitor, a display, a printer, a device, or the like.

Various programs and applications (modules) are stored in the main memory. When these programs and/or applications are executed by the processor, each functional element of the entire system may be realized. Note that each of these modules may be implemented by using a hardware by integrating them or the like. Each module may be an independent program or application. Also, each module may be implemented as sub-programs or functions in a part of a single integrated program or application. In the descriptions, each module can be referred to as a “processing unit”.

In the descriptions, each module (each processing unit) is described as a main part (subject) for carrying out the processing, but the processing may be performed by a processor which processes various programs, applications, or the like (modules) in reality.

Various databases (DB) are stored in the auxiliary storage device. The “database” may refer to a functional element (storage unit) which is able to store a data set so that it may accommodate any data manipulation (e.g., extraction, addition, deletion, or overwriting of data) from a processor or an external computer. The method of implementing the database is not limited, and it may be, for example, a database management system, a spreadsheet software, or a text file such as XML.

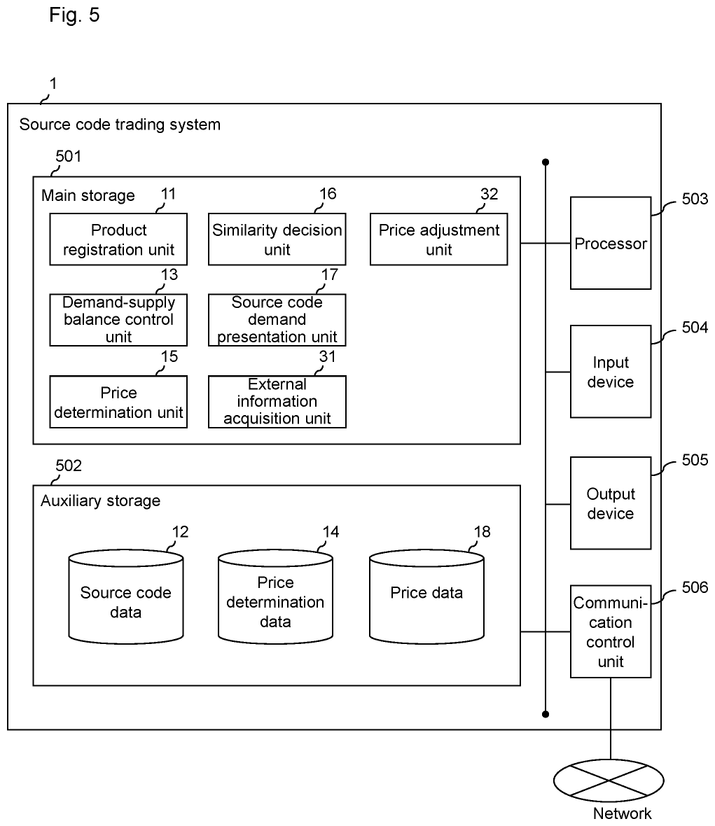

Referring to FIG. 5, therein is illustrated an example of a hardware configuration of the source code trading system 1.

For example, the source code trading system 1 is constituted by a server which is arranged on a cloud.

The main storage 501 stores programs and applications such as the product registration unit 11, the demand-supply balance control unit 13, the price determination unit 15, the similarity decision unit 16, the source code demand presentation unit 17, the external information acquisition unit 31, the price adjustment unit 32 and the like. Each functional element of the source code trading system 1 may be realized by the processor 503 when it executes these programs or applications.

The price determination unit 15 may change and determine the sales price of the source code based on the sales record and the bibliographic information of the source code (e.g., the category of the source code such as the creator, the program language, and the evaluation, etc.).

Furthermore, according to the present embodiment, when a new source code is registered, an analysis of a machine learning based on the information of the already registered source code is performed so that the predicted selling price of the source code is calculated and the selling price is determined.

The similarity decision unit 16 calculates the similarity level between the source codes based on a difference detection algorithm or the like of the character strings.

The external information acquisition unit 31 acquires an external information such as a sales price information relating to the source codes, a news article information and a stock price information relating to the source codes, or the like, periodically or at an arbitrary timing from an external service server 23 such as a code trading site for buying and selling the source codes, a search engine site, a news site for providing news and stock prices.

The price adjustment unit 32 updates the price determined by the price determination unit 15 periodically or at an arbitrary timing based on the external information.

The auxiliary storage 502 comprises the source code data 12, the price determination data 14, and the price data 18.

The source code data 12 registers and stores the source codes which are transmitted from the seller terminal 21.

The price determination data 14 registers information as a basis for the price determination conducted by the price determination unit 15, and stores information such as shown in FIG. 2. Also, external information acquired by the external information acquisition unit 31 may be processed, formed, and stored.

The price data 18 stores an information about the price such as a desired price requested by the seller, a predicted price outputted by the price determination unit 15, a final price adjusted by the price adjustment unit 32, a distribution rate to the reference source codes based on similarity level and the like.

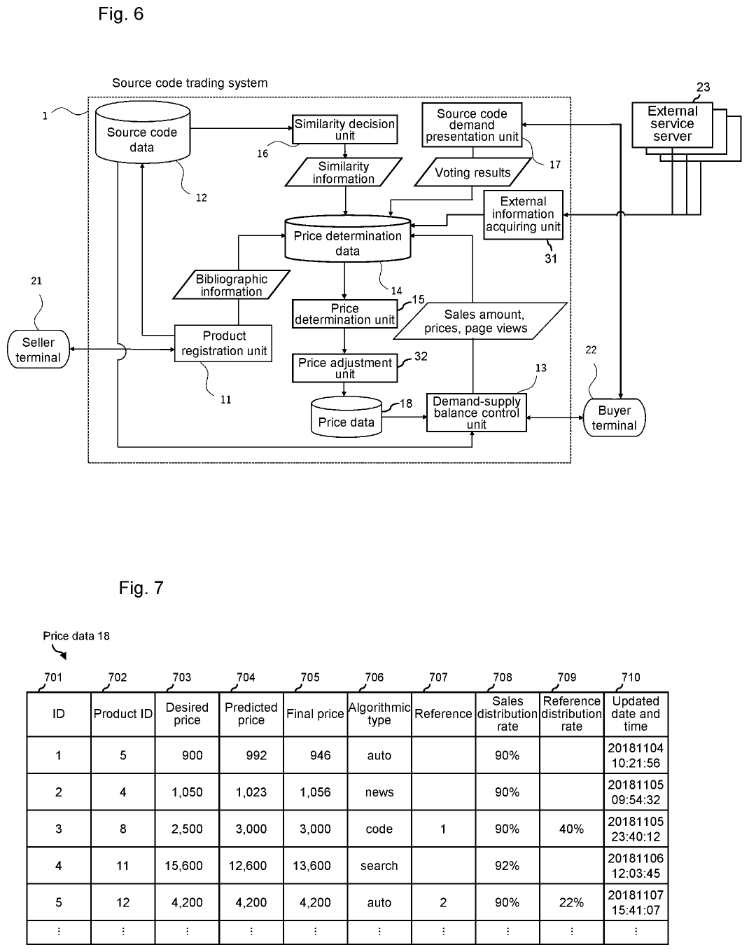

Referring to FIG. 6, therein is illustrated an example of a connection relationship of the entire system 400 which includes the source code trading system 1. Only points of differences from Example 1 will be described below.

The external information acquisition unit 31 is connected to the external service server 23 via a network and acquires various external information. The external information acquisition unit 31 processes, forms, or evaluates the acquired information and stores the information in the price determination data 14 in a form to be processed by the price determination unit 15 and the price adjustment unit 32.

The price adjustment unit 32 adjusts the price determined by the price determination unit 15 based on the price determination data 14 periodically or at an arbitrary timing in accordance with the information based on the external information stored in the price determination data 14.

Referring to FIG. 7, therein is illustrated a configuration example of the price data 18.

The price data 18 includes an ID 701, a product ID 702, a desired price 703, a predicted price 704, a final price 705, an algorithmic type 706, a reference 707, a sales distribution rate 708, a reference distribution rate 709, and an updated date and time 710.

The ID 701 is an information which is generated sequentially when the price of the source code is determined.

The product ID is an information for identifying the “product” which includes the actual source code. The product ID refers to the product ID of the product information (not shown). The product information includes an information about the product in association with the source code. For example, it may include an information such as a user ID, a name of user, a status, a price history, product details, design details, a usage, a limitation, a product image, a preview URL, a product video URL, a user guide, an initial price (desired price), and the like.

The desired price 703 includes the seller's desired selling price.

The predicted price 704 includes the predicted sales price of the source codes based on the sales record and the bibliographic information of the source code (e.g., the creator, the program language, the evaluation, and the category, etc.) and the predicted sales price which may be calculated by performing an analysis of a machine learning based on the information of other already registered source codes.

The final price 705 is a price in the final outcome calculated based on adjustments of the desired price 703, the predicted price 704 and the external information.

Algorithm type 706 indicates which algorithm is used to determine the final price. “Auto” indicates that it is calculated by performing an analysis by using a machine-learning based on the predicted sales prices of the source code on a basis of the sales record and the bibliographic information of the source code (e.g., the creator, the programming language, the evaluation, the categories, etc.) and the information of other already registered source codes.

“News” indicates that it is calculated based on an information which is acquired from the news site.

“Code” indicates that it is calculated based on a price information of other source-code trading sites.

“Search” indicates that it is calculated based on an information which is obtained from retrieval site.

Reference 707 relates to an information that refers to other source code in a case that the source code has been created by copying or modifying the other source code. It refers to the product ID in the product information.

The sales distribution rate 708 defines a sales distribution rate to be paid to the seller after selling the source code. Although the amount is given as a percentage in this example, it is also possible to distribute the amount after deducting a predetermined cost or commission for the sale. It is only necessary to describe how the sales proceeds can be distributed in a specific manner.

In a case of referring to other source code, the reference distribution rate 709 defines a distribution rate for distributing a part of the sales to the seller of the referred-to source code. For example, in a case that 30% of the source code are diverted from the other source code, 30% of the sales are distributed to the sellers of the other source code.

The updated date and time 710 store the date and time when the information has been updated.

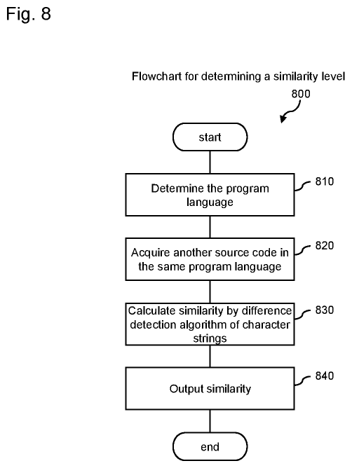

Referring to FIG. 8, therein is illustrated an example of a flowchart 800 of a method adapted to determine a similarity level.

The similarity decision unit 16 determines the program language of the source code which is acquired from the source code data 12 (step 810). The similarity decision unit 16 may determine it based on the language 14d2 of the bibliographic information (bibliographic matter) 14d. Also, the similarity decision unit 16 may determine it by analyzing the syntax of the source code.

The similarity decision unit 16 acquires the other source code from the source code data 12 wherein the other source code is described in the same program language of the determined program language (step 820). It is feasible to improve the search efficiency by searching only within the same or related category as the new source code, according to the category of the source code which is registered in the bibliographic information beforehand.

The similarity decision unit 16 calculates the similarity level by using a difference detection algorithm of the character strings (step 830), and the similarity decision unit 16 outputs and displays the results (step 840).

As the difference detection algorithm, it is feasible to use a method of determining a distance between character strings by using Levenshtein distance, a method of using Myers difference algorithm (Myers Diff algorithm), and the like.

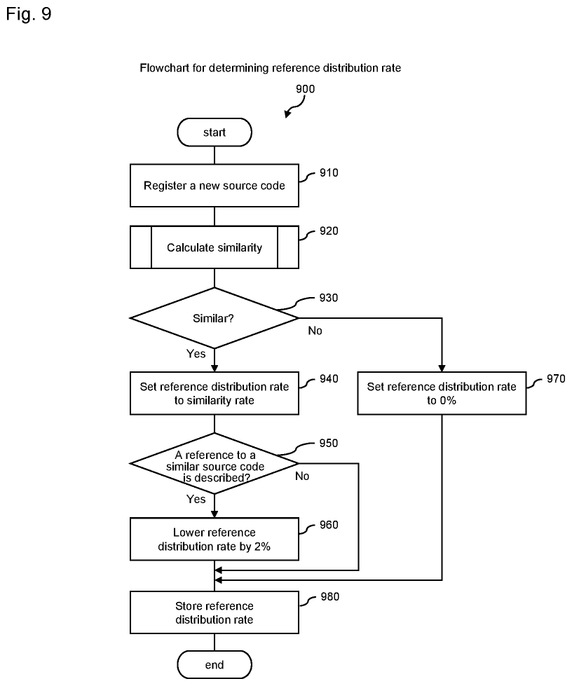

Referring to FIG. 9, therein is illustrated an example of a flowchart 900 of a method adapted to determine a reference distribution rate.

The product registration unit 11 receives a registration of a new source code (step 910).

The similarity decision unit 16 calculates a similarity level to determine whether the new source code is similar to a source code which is stored in the source code data 12 in the past (step 920).

In a case that other similar source code exists, the similarity decision unit 16 uses a ratio of a portion similar to the other source code in the new source code (the ratio of the similar portion) as the reference distribution rate. For example, in a case that 30% of the new source code are similar to the other source code, then the 30% are set as the reference distribution rate (step 940).

Next, the similarity decision unit 16 determines whether a reference to the other source code which is determined to be similar is described in the new source code or not (step 950).

In a case that the reference is describe therein, the distribution rate for the new source code is increased as an incentive to legitimately disclose relying on the other source code. That is, the reference distribution rate may be lowered by, for example, 2% (step 960).

In a case that any similar source code is not found out in the similarity decision step 930, the similarity decision unit 16 sets the distribution rate of the new source code to 100%. That is, the reference distribution rate is set as 0% (step 970).

The similarity decision unit 16 stores the reference distribution rate in the reference distribution rate 709 of the price data 18 (step 980).

Although the distribution rate is adjusted as an incentive for reference description, these steps 950 and 960 are able to be omitted in terms of the configuration.

Also, the incentive structure is set to lower the reference distribution rate and increase the distribution rate of the new source code. Instead of that or in parallel with that, the incentive may be created by increasing the sales distribution rate 708 to sales in terms of the configuration.

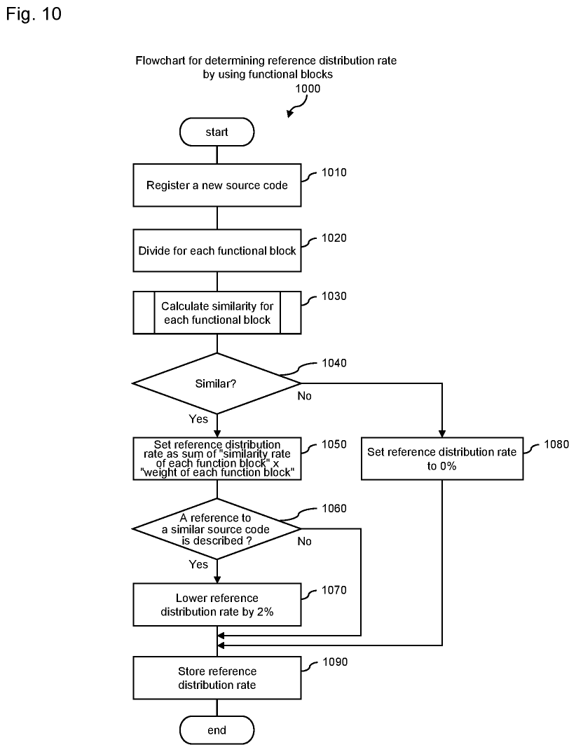

Referring to FIG. 10, therein is illustrated an example of a flowchart 1000 of a method adapted to determine a reference distribution rate by using functional blocks.

The product registration unit 11 receives a registration of a new source code (step 1010).

The similarity decision unit 16 divides the new source code for each functional block (step 1020). Usually, the source code is divided into specifications for several functions. For example, the source code of the EC site may include a customer management function, a settlement function, a product management function, a sales interface generation function, and an order management function and the like. In a case of the source code of the game, there will be a login management function, a user input processing function, a screen generation function, an output management function, a 3D model processing function, and the like.

Although the contents of the source codes may be different for each category of the source codes, the source code may have similar things in functional terms, in many cases. For example, in the case of an EC site, even if the design, the method of managing the product, and the like are different, the source codes of any EC site usually have the above-mentioned various functions in many cases.

The categories (genres) of the source codes may be classified into a management system, a Web system, a batch processing system, an embedded system, an audio and video processing system, a data processing system, a game system, and the like as major classifications. The major classifications may be classified into medium classifications and/or small classifications. For example, as the intermediate classification of the Web system, these may be classified into a Web site construction software, a CSS design, a HTML design, a JavaScript (registered trademark) process, an EC site, and the like. These information are registered in the bibliographic information.

The similarity decision unit 16 analyzes the new source code and divide the source code for each function block based on the information of the structure of general function block which is registered in advance for each of the same or related categories based on the bibliographic information. By searching or analyzing explanations described in the comment column which is described in the source code, and/or by searching or analyzing frequently used functions and modules, it is feasible to identify the break parts of the functions of the source code and to divide the function block.

Also, it is feasible to identify the break parts of functions so as to specify the function blocks manually for every registration.

Each of the divided function block may be set with an importance level and a weight coefficient based on the importance level. For example, in a case of an EC site, the importance level of the product management function and the settlement function may be set to “high”, and the importance level of the customer management function and the sales interface generation function may be set to “medium”.

The similarity decision unit 16 calculates the similarity level to determine whether each of the divided functional block is similar to the source code which is stored in the source code data 12 in the past (step 1030).

In a case that other similar source code exists, the similarity decision unit 16 obtains a ratio of a portion similar to other source code(s) in the new source code for each function block (a rate of similar part); multiplies the result by a weighting coefficient of each function block; and determines a reference distribution rate by summed up all the values (step 1050).

For example, suppose that a certain source code is composed of three functional blocks A, B, and C, and these weighting coefficients based on the importance levels in the respective source codes are 20%, 50%, and 30%. Furthermore, suppose that the percentages of the other source code copied by the A, B, and C are 70%, 20%, and 80%, respectively. In this case, the degrees of reliance of the A, B, and C for the other source codes are multiplied by the respective values and the results are 14%, 10%, and 24%, respectively.

As a result, the total degree to which this source code depends on the other source code is 48% of these totals, and this number is used as the reference distribution rate.

Next, the similarity decision unit 16 determines whether a reference to the other source code(s) determined to be similar is described in the new source code (step 1060).

In a case that the reference is described therein, the distribution rate for the new source code is increased as an incentive to legitimately disclose relying on the other source code. That is, the reference distribution rate is lowered by, for example, 2% (step 1070).

In a case that any similar source code is not found out in the similarity decision step 1040, the similarity decision unit 16 sets the distribution rate of the new source code to 100%. That is, the reference distribution rate is set to 0% (step 1080).

The similarity decision unit 16 stores the reference distribution rate in the reference distribution rate 709 of the price data 18 (step 1090).

The demand-supply balance control unit 13 receives an order from the buyer terminal 22. In a case that the source code is sold, the sales distribution profit is calculated by multiplying the sales price by the sales distribution rate 708 of the price data 18. Then, the demand-supply balance control unit 13 distributes the sales distribution profit between the seller terminal 21 of the sold source code and the seller terminal 21 of the referred-to source code based on the reference distribution rate 709.

In this embodiment, the similarity level of the source code may be used in this manner to distribute the sales to the reference source code, and enhance the incentive of the source code seller.

### 3^{rd} Embodiment

In the present embodiment, a method of determining and adjusting the sales price of the source code will be described.

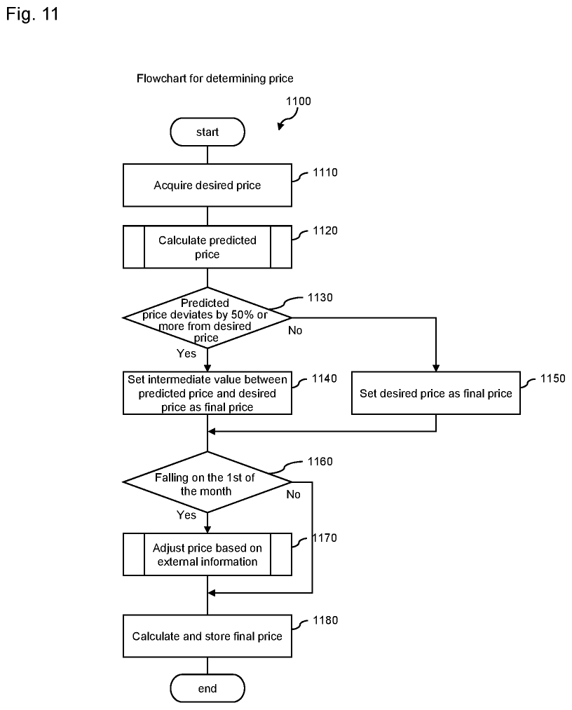

Referring to FIG. 11, therein is illustrated an example of a flowchart 1100 of a method adapted to determine a price.

The price determination unit 15 acquires the desired price 703 which is inputted by the seller terminal 21 from the price data 18 (step 1110).

The price determination unit 15 calculates a predicted price (predicted sales price) of the source code based on the information described in the price determination data 14 (step 1120).

In a case that the predicted price deviates by 50% or more from the desired price (step 1130), the final price is set to be an intermediate value between the predicted price and the desired price (step 1140). Or, in a case that the predicted price does not deviate by 50% or more, the desired price is set as the final price (step 1150).

For example, in a case that the desired price is 1000 yen and the predicted price is 2000 yen, the final price is set to be 1500 yen as middle of them. It should be noted that rather than the middle value between the predicted price and the desired price, it may be set at 25% of the difference between the predicted price and the desired price (the final price becomes 1250 yen in the previous example). Or the predicted price may be set as the final price (the final price becomes 2000 yen in the previous example). Either way, in a case that the predicted price is higher than the desired price, the final price is set higher than the desired price.

Conversely, in a case that the predicted price is lower than the desired price, it is feasible to set the final price of the amount lower than the desired price in like manner. Or it is feasible to set the final price as the desired price not to be reduced as a configuration so as to respect the intention of the seller terminal 21.

In a case of lowering the price, supposing that the desired price is 1000 yen and the predicted price is 600 yen, the final price is set to be 800 yen in the middle of them. It should be noted that rather than the middle value between the predicted price and the desired price, it may be set at 25% of the difference between the predicted price and the desired price (the final price becomes 900 yen in the previous example). Or the predicted price may be set as the final price (the final price becomes 600 yen in the previous example).

In the current configuration, the above-mentioned flow is constructed to adjust the price only when the predicted price deviates by 50% or more from the desired price so that a large number of minor adjustments will not be required. However, it is feasible to construct the present flow to adjust the price when a deviation occurs at any degree without requiring the step 1130.

The predicted price calculation process 1120 is repeatedly calculated for a relatively short period of time (e.g., once a day), to adjust the final price. In the second and subsequent calculations, the current final price is used instead of the desired price, and the final prices are sequentially updated.

It should be noted that, in a case that the amount of the product (source code) of a specific language disclosed by the external service server is large within a certain period of time, the predicted price calculation processing of the source code may be performed.

For example, the external information acquisition unit 31 acquires a list of the products from the source code providing site. In a case that a ratio related to a newly introduced (updated) products into the source code providing site against the products of the same programming language as the specific source codes of the own system exceeds a predetermined value (e.g., 5%), the predicted price calculation processing is performed.

For example, in this case, it is feasible to construct to calculate the predicted price of all the products related to the programming language of the own system.

The price adjustment unit 32 performs price adjustments of the final price based on the external information once a month (step 1160 and step 1170). The acquisition of the external information may be performed once a month. It is feasible to perform the acquisition of the external information more frequently (for example, once a day, etc.), and the information based on the external information may be sequentially stored in the price determination data 14 so as to perform price adjustments based on the data once a month.

As the result, the modified final prices are stored in the final price 705 of the price data 18 (step 1180).

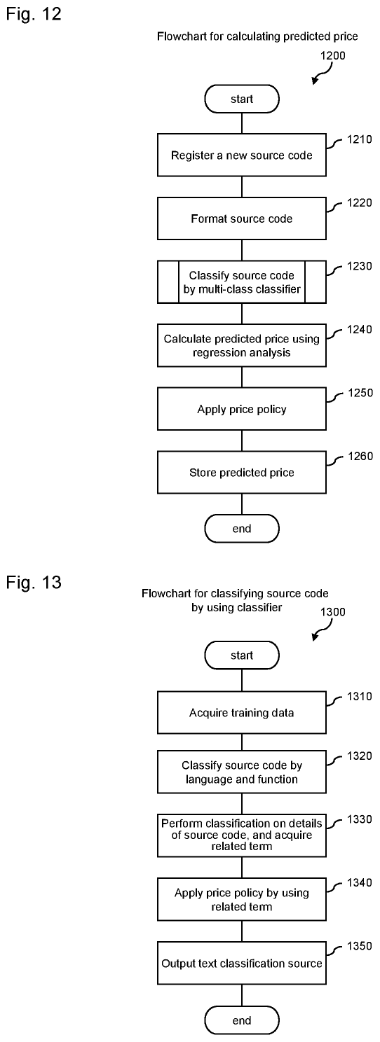

Referring to FIG. 12, therein is illustrated an example of a flowchart 1200 of a method adapted to calculate a predicted price.

The product registration unit 11 receives a registration of a new source code (step 1210).

The price determination unit 15 forms the source code into a form to be processed (step 1220). Then, a classification of the source code is performed by using a multi-class classifier to classify the source code (step 1230).

The price determination unit 15 performs a regression analysis by using a machine learning on the classified source code so as to calculate a predicted price for the source code (step 1240). For example, a gradient boosting regression analysis may be used as a regression analysis method. However, the present example is not limited thereto, and other price calculation algorithms may be used.

The price determination unit 15 applies a price policy to the calculated predicted price (step 1250) so as to check whether the amount of the price is appropriate according to the policy or not.

The price determination unit 15 stores the calculated predicted price in the price data 18 (step 1260).

Referring to FIG. 13, therein is illustrated an example of a flowchart 1300 of a method adapted to classify a source code by using a classifier.

The price determination unit 15 acquires a training data (step 1310).

The price determination unit 15 performs classification based on the bibliographic information such as the program language of the source code and the category (function) or the like to classify the source code by eliminating a duplication (step 1320).

The price determination unit 15 further performs a classification on the details of the source code described in the product details of the product information which corresponds to the classified source code so as to acquire a related term (step 1330). For example, a Bag-of-words classification may be used as the classification method.

The price determination unit 15 performs a text classification by using the related terms (step 1340). For example, a simple Bayesian classification may be used for the classification. For example, it is feasible to train the data based on the training data obtained at the step 1310 and the related terms obtained at the step 1330, and to perform a simple Bayesian classification by applying a classification model.

The price determination unit 15 outputs a text classification score such as a Bayesian score (step 1350).

The price determination unit 15 performs a classification of the source code based on the obtained text classification score.

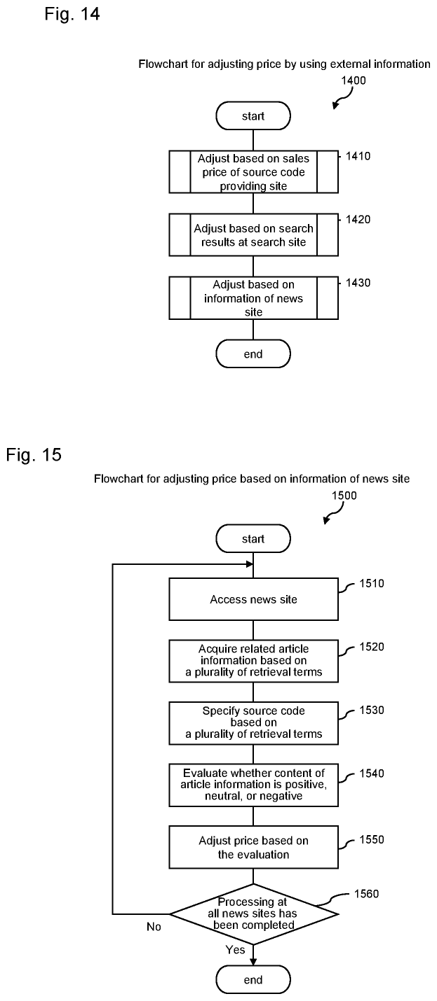

Referring to FIG. 14, therein is illustrated an example of a flowchart 1400 of a method adapted to adjust a price by using external information.

As described with reference to FIG. 11, the price determination unit 15 calculates the sales price of the source code based on at least one of the contents of the source code, the buying and selling information, and the bibliographic information at a relatively short frequency, such as once every day. On the other hand, the price adjustment unit 32 adjusts the sales price determined by the price determination unit 15 based on the information acquired from the external service server 23 at a frequency longer than the price determination period of the price adjustment unit 32, such as once a month.

The demand-supply balance control unit 13 displays fluctuating prices (dynamic prices) which are successively changed (dynamic pricing).

The price adjustment unit 32 adjusts the price based on the adjustments according to the sales price of the source code providing site (step 1410).

The external information acquisition unit 31 acquires an information for specifying the source code and the sales price of the source code (the price of the source code providing site) from the product information of the source code providing site. For example, the external information acquisition unit 31 accesses a page of a new product announcement of the source code providing site to scrapes the detailed information of the source code and the information of the sales price which are sequentially listed thereto so that the external information acquisition unit 31 may acquire the information identifying each source code (e.g., the source code name, the name of creator, the sales company, the model number, the version name, the program language, etc., or some combination of them to identify the source code). Then, the external information acquisition unit 31 sequentially stores the information in the price determination data 14 after forming the information.

The price adjustment unit 32 acquires the information of the source code held by the own system corresponding to the information for specifying the source code which is posted on the source code providing site; and adjusts the sales price based on the price of the source code providing site.

In a case that the price of the source code providing site is higher than the current sales price of the own system, the price adjusting unit 32 increases the sales price of the source code of the own system. For example, the price is set to the same price as the price of the source code providing site. Alternatively, it may be set to a price in between that of the price of the source code providing site and the current sales price.

For example, in a case that the price of the source code providing site of the source code A listed on the source code providing site is 2000 yen and the selling price of the source code corresponding to the current source code A of the source code trading system 1 is 1000 yen, then the final selling price is set to 1500 yen arranged in the middle of them.

Rather than the intermediate value between the price of the source code providing site and the current sales price, it is feasible to set the price at 25% of the difference between the price of the source code providing site and the current sales price (for the previous example, the final sales price becomes 1250 yen). Also, it is feasible to set the price of the source code providing site price as the sales price (for the previous example, the final sales price becomes 2000 yen).

Also, in a case that the price of the source code providing site is lower than the current price, it is feasible to lower to the final sales price so as to be lower than the sales price in like manner. Also, it is feasible to maintain the final sales price to hold the current sales price as it is in order to respect the seller's intention.

In a case of lowering the price, for example, supposing that the price of the source code providing site is 600 yen and the current sales price is 1000 yen, then the final sales price is set to 800 yen as the intermediate value of them. It should be noted that, instead of the intermediate value between the price of the source code providing site and the current sales price, it is feasible to arrange the price at 25% of the difference between the price of the source code providing site and the current sales price from the price of the source code providing site (for the previous example, the final sales price becomes 900 yen). Also, it is feasible to set the price of the source code providing site as the final sales price (for the previous example, the final sales price becomes 600 yen).

It should be noted that the price adjustment may not be performed immediately when there is a price difference. Instead of that the price adjustment of the source code may be performed when the amount of the products (source codes) of the specific language disclosed by the external service server is large within a certain period of time.

For example, the external information acquisition unit 31 acquires a list of products from the source code providing site. The price adjustment is performed when a rate related to the products newly introduced into the source code providing site against the products of the same programming language as the source code of the own system exceeds a predetermined value (e.g., 5%).

In this case, it is feasible to acquire the information of all products of the same programming language to use for classification and price calculation processing.

Next, the price adjustment unit 32 adjusts the price based on the adjustments according to the searching results of the search site (step 1420).

The price determination data 14 stores a plurality of search terms corresponding to the source code stored in the source code data 12. The external information acquisition unit 31 searches information related to the source code corresponding to the stored source code based on the search terms by using the search site. For example, the information such as that described in source code categories, tags, detailed information, and the like may be stored as search terms.

Through the search, an information for specifying the corresponding source code and a price information of the source code (the price of the search site) may be acquired.

The price adjustment unit 32 adjusts the sales price of the source code of the own system corresponding to the information for specifying the source code based on the price of the search site.

For example, the price adjustment unit 32 increases the sales price in a case that the price of the search site is higher than the current sales price. For example, the sales price is set to the same price as the price of the search site. Alternatively, the price is set to a price which is intermediate between the price of the search site and the current sales price.

For example, in a case that the price of the search site of the source code “B” found by the search is 2000 yen and the sales price of the source code corresponding to the current source code “B” of the source code trading system 1 is 1000 yen, then the final sales price is adjusted to 1500 yen in the middle of them.

It is feasible to set the price at 25% of the difference between the current sales price and the price of the search site price from the current sales price (for the previous example, the final sales price becomes 1250 yen), rather than the intermediate value between the price of the search site and the current sales price. Also, it is feasible to set the price of the search site as the sales price (for the previous example, the final sales price becomes 2000 yen).

Also, in a case that the price of the search site is lower than the current price, it is feasible to reduce to the final sales price lower than the sales price in like manner. Also, it is feasible to maintain the final sales price to keep the current sales price as it is in order to respect the seller's intention.

In a case that the price is lowered, for example, when the price of the search site is 600 yen and the current sales price is 1000 yen, the final sales price is set to 800 yes as an intermediate value. It should be noted that, instead of the intermediate value between the price of the search site and the current sales price, it is feasible to set the price at 25% of the difference between the price of the search site and the current sales price from the price of the search site (for the previous example, the final sales price becomes 900 yen). Or the price of the search site may be set as the final sales price (for the previous example, the final sales price becomes 600 yen).

The price adjustment unit 32 adjusts the price based on the information of the news site (step 1430). Details will be described below with reference to FIG. 15.

Also, it is feasible not to perform all of the adjustments based on the sales price of the source code providing site (step 1420), the adjustments based on the searching results of the search site (step 1430), and the adjustments based on the information of the news site (step 1430). Also, it is feasible to perform any one of them. Furthermore, it is feasible to set the execution frequency and timing differently from each other.

Instead of adjusting the price immediately in response to the acquisition of one piece of external information, a plurality of pieces of external information may be accumulated, for example, for one month, and these pieces of information may be analyzed, integrated, averaged, and the like, and then executed once a month.

Referring to FIG. 15, therein is illustrated an example of a flowchart 1500 of a method adapted to adjust a price based on the information of news site.

The price determination data 14 stores a plurality of search terms corresponding to the source code stored in the source code data 12.

The external information acquiring unit 31 accesses to a news site which distributes news (step 1510). Then, the external information acquiring unit 31 acquires an information for specifying the source code corresponding to the stored source code from the news site (for example, one of information such as a source code name, a name of creator, a sales company, a model number, a version name, a program language, or a combination of some of them which can be used to specify the source code) and acquires a related article information (step 1520 and step 1530).

For example, it is feasible to access to a news site to acquire a title and contents of article in a predetermined period (e.g., one month in the past) so as to acquire the article information corresponding to the source code by extracting data which is hit by the search term. Alternatively, it is feasible to acquire a stock price information of manufacturer or distributor of the source code, for example.

The external information acquisition unit 31 may evaluate whether the content of the acquired article information is positive, neutral, or negative (step 1540). This processing may be executed by the price adjustment unit 32.

The price adjustment unit 32 adjusts the current sales price of the source code of the own system corresponding to the information for specifying the source code which is posted on the news site, based on the evaluation of the content of the article information (step 1550).

For example, in a case that the content of the article information is evaluated positively, the sales price is raised. In a case that the content of the article information is evaluated negatively, the sales price is lowered. Also, it is feasible to maintain the current price as it is in order to respect the seller's intention.

The price determination data 14 stores a plurality of article terms indicating positive contents (positive article terms) and a plurality of article terms indicating negative contents (negative article terms). The external information acquisition unit 31 analyzes whether the article terms indicating positive contents are included in the article information acquired from the news site and analyzes how many articles terms are included so as to evaluate whether the contents of the article information are positive or not.

For example, the external information acquisition unit 31 evaluates the contents of the article information to be positive in a case that the number of positive article terms included in the article information exceeds a predetermined number or ratio (e.g., 10 words or more per 1000 words or 1% or more), or in a case that the number of positive article terms included in the article information exceeds the number of article terms indicating negative contents.

For example, in a case that the article information is related to a stock price, the contents may be evaluated positively when the stock price of the source code manufacturer or distributor rises, or when investors, financial institutions, or the like evaluate that the stock price is likely to rise.

The price adjustment unit 32 completes the processing in a case that the search has been completed for all news sites stored in the price determination data 14 as the targets of the search (step 1560).

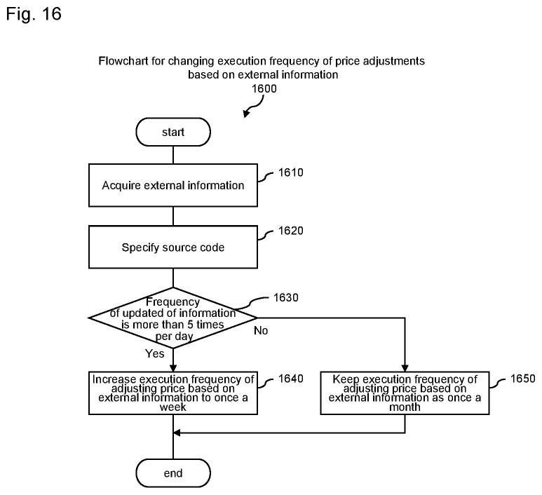

Referring to FIG. 16 therein is illustrated an example of a flowchart 1600 of a method adapted to change an execution frequency of price adjustments based on external information.

The price determination unit 15 calculates the sales price of the source code based on at least one of the contents of the source code, the trade information, and the bibliographic information at a relatively short frequency, such as once every day. On the other hand, the price adjustment unit 32 adjusts the sales price determined by the price determination unit 15 based on the information acquired from the external service server 23 at a frequency longer than the price determination period of the price adjustment unit 32, such as once a month.

This is because the external information acquired from the external server is not generated all the time but it is generated only partially, and the fluctuation of the price may be stabilized in a case that the price is accumulated to some extents once and then is adjusted; and is because that the processing of analyzing external information is heavy processing that tends to consume computer resources, and the load tends to be high when the processing is executed at high frequency.

However, there is a case that it may be possible to reflect the price of the source code more appropriately when the price adjustments by external information are performed more frequently if a specific event occurs.

The external information acquisition unit 31 acquires an external information such as a sales price information relating to the source code, a news article information and a stock price information related to the source code, and the like from an external service server 23 such as a code trading site for buying and selling the source code, a search engine site, a news site for providing news and stock prices, and the like (step 1610).

The external information acquisition unit 31 specifies the source code by using the external information (step 1620).

In a case that the newly posted frequency of the external information with respect to the specified source code is not high (e.g., less than five times a day) (step 1630), the execution frequency of price adjustments based on the external information is kept as once a month as it is (step 1650). On the other hand, in a case that the newly posted frequency of the external information is high (e.g., five or more times a day) (step 1630), the execution frequency of price adjustments based on the external information with respect to the specified source code is increased (e.g., increased to once a week) (step 1640).

By having such a configuration, it is feasible to adjust prices more frequently so as to present sales prices closer to social needs when social interest in a specific source code has been raised, while normally keeping the price adjustment load of a computer such as once a month.

In another method, it is feasible to increase the frequency of the price adjustments of the source code in a case that the amount of the products of the specific source code is large within a certain period of time.

For example, the external information acquisition unit 31 acquires a list of products from the external service server 23 (e.g., a source code providing site, a search site, a news site, etc.).

The external information acquisition unit 31 increases the execution frequency of price adjustments or executes price adjustments in a case that the number of pieces of external information relating to the specified source code in the total number of products in the same programming language as the specified source code exceeds a predetermined value, for example, 5%.

In another method, it is feasible to increase the frequency of the price adjustments of the source code in a case that the update frequency (fluctuation) of the price of the specific source code is large within a certain period of time.

For example, the external information acquisition unit 31 acquires a list of products from the external service server 23 (e.g., a source code providing site, a search site, a news site, etc.).

The external information acquisition unit 31 increases the execution frequency of the price adjustments in a case that the update frequency (variation) of the price of the source code of the external service server which is the same as or related to the specified source code exceeds a predetermined value (for example, once a week).

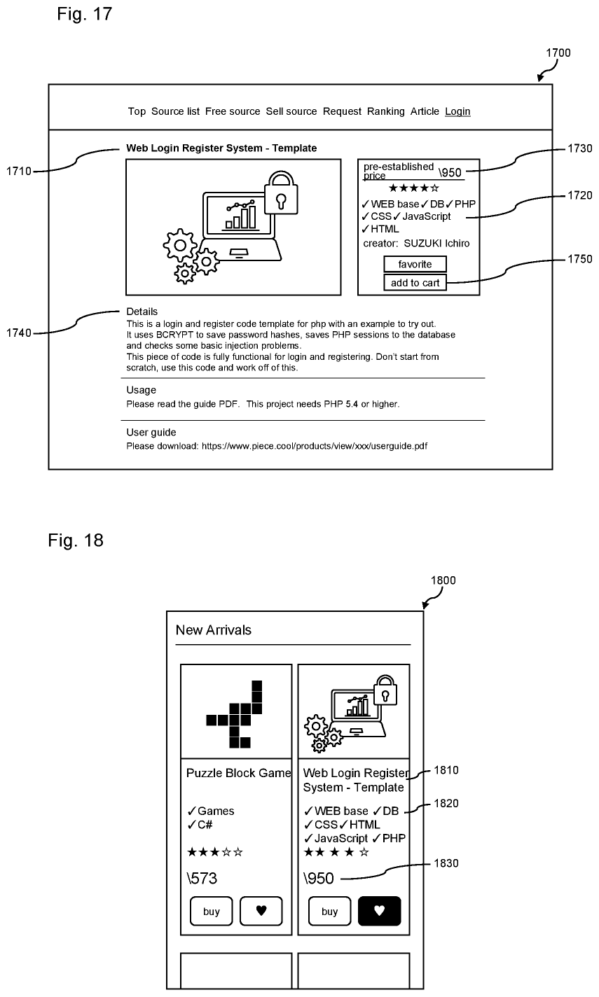

Referring to FIG. 17, therein is illustrated an example of a Web screen 1700.

The demand-supply balance control unit 13 displays a Web screen 1700 for selling the source code to the buyer terminal 22. The Web screen 1700 includes a title 1710 of the source code, a detailed information 1740, a bibliographic information 1720 (such as a program language, a name of creator, a category, a tab, or the like), a price indication 1730, and an “add to cart” button 1750 for purchasing the source code.

Revising a sales price is conducted based on the pricing flow in FIG. 11 at the frequency of once every day or more so as to update the prices in the price indication 1730. Also, price adjustments are conducted based on the external information at the beginning of the month so as to update the prices in the price indication 1730 depending on the contents and the amount of the external information.

Referring to FIG. 18, therein is illustrated an example of a smartphone screen 1800.

The smartphone screen 1800 includes a title 1810 of the source code, a bibliographic information 1820, and a price indication 1830. By tapping the title or the like, the screen can be changed to display the detailed information of the source code.

Also at the smartphone screen, revising the sales price is conducted at the frequency of once every day or more so as to update the price in the price indication 1830. Also, price adjustments are conducted based on the external information at the beginning of the month so as to update the prices in the price indication 1830 depending on the contents and the amount of the external information.

In a case that the source code uses a part of the other source code, the reference code 707 and the reference distribution rate 709 (or the usage rate of the reference code) may be displayed in FIG. 17 or FIG. 18.

The present invention is not limited to the above-described embodiments, and the present invention can be modified in various ways. For example, the above-described examples have been described in detail for the purpose of illustrating the present invention easily, and are not necessarily limited to those comprising all the described configurations. It is also possible to replace a part of the configuration of one embodiment with the configuration of another embodiment, and it is also possible to add the configuration of another embodiment to the configuration of one embodiment. Further, it is possible to add, delete, or replace a part of the configuration of each embodiment.

In addition, some or all of the above-described configurations, functions, processing units, processing means, and the like may be realized by hardware, for example, by designing them by an integrated circuit. In addition, each of the above-described configurations, functions, and the like may be implemented by software by interpreting and executing a program in which the processor realizes its respective functions. Information such as programs, tables, and files that realize various functions can be stored in a memory, a recording device such as a hard disk or an SSD (Solid State Drive), or a recording medium such as an IC card, an SD card, or a DVD.

In addition, the control lines and the information lines indicate those which are considered to be necessary for the purpose of explanation, and not all the control lines and the information lines are necessarily indicated in terms of products. Actually, it may be considered that almost all the configurations are connected to each other.

### DESCRIPTION OF SYMBOLS

1 . . . Source Code Trading System, 11 . . . Product Registration Unit, 12 . . . Source Code Data, 13 . . . Demand-Supply Balance Control Unit, 14 . . . Price Data, 15 . . . Price Determination Unit, 16 . . . Similarity Decision Unit, 17 . . . Source Code Demand Presentation Unit, 21 . . . Seller Terminal, 22 . . . Buyer Terminal, 23 . . . External Service Server, 31 . . . External Information Acquisition Unit, 32 . . . Price Adjustment Unit, 502 . . . auxiliary storage

1. A source code trading system for buying and selling a source code of a software, the source code trading system comprising:
a storage device for storing the source code;
a price determination unit for calculating a first sales price of the source code based on at least one of a content of the source code, a buying and selling information, and a bibliographic information;
an external information acquisition unit for acquiring an information from an external service server located outside the source code trading system;
a price adjustment unit for adjusting the first sales price based on the information obtained from the external service server and calculating a second sales price; and
a demand-supply balance control unit for displaying the calculated second sales price.

2. The source code trading system of claim 1,
wherein the external information acquisition unit acquires an information for specifying a second source code and an information relating to a price at a source code providing site indicating a sales price of the second source code, from a product information at the source code providing site which is one of the external service servers, and
wherein the price adjustment unit calculates the second sales price by adjusting the first sales price of the source code stored in the storage device corresponding to the information for specifying the second source code, based on the information relating to the price at the source code providing site.

3. The source code trading system of claim 2,
wherein the price adjustment unit sets the second sales price higher than the first sales price in a case where the price at the source code providing site is higher than the first sales price.

4. (canceled)

5. (canceled)

6. The source code trading system as claimed in claim 1,
wherein the storage device stores a plurality of search terms corresponding to the source code,
wherein the external information acquisition unit acquires an information for specifying a third source code searched based on a plurality of search terms and an information relating to a price at a search site indicating a price corresponding to the third source code, from a search site which is one of the external service servers, and
wherein the price adjustment unit calculates the second sales price by adjusting the first sales price of the source code stored in the storage device corresponding to the information for specifying the third source code, based on the information relating to the price at the search site.

7. The source code trading system of claim 6, wherein the price adjustment unit sets the second sales price higher than the first sales price in a case where the price at the search site is higher than the first sales price.

8. (canceled)

9. The source code trading system as claimed in claim 1,
wherein the storage device stores a plurality of second search terms corresponding to the source code,
wherein the external information acquisition unit acquires an information for specifying a fourth source code and an article information searched based on a plurality of the second search terms, from a news site for distributing news which is one of the external service servers, and evaluates whether a content of the article information is positive or not, and
wherein the price adjustment unit calculates the second sales price by adjusting the first sales price of the source code stored in the storage device corresponding to the information for specifying the fourth source code, based on an evaluation of the content of the article information.

10. The source code trading system of claim 9, wherein the second sales price is set higher than the first sales price in a case where the evaluation of the content of the article information is positive.

11. The source code trading system as claimed in claim 9,
wherein the storage device stores a plurality of article terms indicating positive contents, and
wherein the external information acquisition unit evaluates the content of the article information as positive based on the article terms included in the article information.

12. The source code trading system of claim 11, wherein the external information acquisition unit evaluates the content of the article information as positive in a case where a number of the article terms included in the article information is larger than a number of a plurality of article terms indicating negative contents included in the article information.

13. The source code trading system as claimed in of claim 9, wherein the external information acquisition unit increases a calculation frequency of the second sales price by the price adjustment unit in a case where a distribution frequency of the article information relating to the information for specifying the fourth source code exceeds a predetermined value.

14. The source code trading system as claimed in claim 1, further comprising a similarity determination unit for determining a similarity level of the source code,
wherein the similarity determination unit calculates a use rate of a similar source code to a new source code in a case where the similar source code, which is similar to the new source code, is stored in the storage device, and
wherein the price determination unit determines a distribution rate of the sales price of the new source code based on the use rate.

15. The source code trading system of claim 14, wherein the similarity determination unit divides the new source code into a plurality of function blocks and determines a similarity level with the source code stored in the storage device for each function block.

16. The source code trading system of claim 14,
wherein the similarity determination unit calculates an importance level of the new source code for each functional block, and
wherein the price determination unit determines the distribution rate of the sales price of the new source code based on the similarity level for each functional block and the importance level for each functional block.

17. The source code trading system claim 14, wherein the price determination unit increases the distribution rate of the sales price to the new source code in a case where the similar source code similar to the new source code is stored in the storage device and a reference information to the similar source code is described in the new source code.

18. (canceled)

19. (canceled)

20. (canceled)

21. A method for trading a source code of a software in a source code trading system comprising:
storing a source code to be sold;
calculating a first sales price of the source code based on at least one of a content of the source code, a buying and selling information, and a bibliographic information;
adjusting the first sales price based on an information obtained from the external service server located outside the source code trading system and calculating a second sales price; and
displaying the calculated second sales price.

22. The method for trading source code of claim 21, further comprising:
acquiring an information for specifying a second source code and an information relating to a price at a source code providing site indicating a sales price of the second source code from a product information at the source code providing site which is one of the external service servers, and,
adjusting the first sales price of the source code stored in the storage device corresponding to the information for specifying the second source code, based on the information relating to the price at the source code providing site so as to calculate the second sales price.

23. The method of trading the source code of claim 22, wherein the storage device stores a plurality of search terms corresponding to the source code, the method further comprising:
acquiring an information for specifying a third source code searched based on the plurality of search terms, and an information relating to a price at a search site indicating a price corresponding to the third source code, from a search site which is one of the external service servers, and
adjusting the first sales price of the source code stored in the storage device corresponding to the information for specifying the third source code, based on the information of the price at the search site so as to calculate the second sales price.

24. The method for trading source code claim 21, wherein the storage device stores a plurality of second search terms corresponding to the source code, the method further comprising:
acquiring an information and an article information for specifying a fourth source code searched based on the second search term from a news site for distributing news which is one of the external service servers, and evaluating whether a content of the article information is positive or not, and
adjusting the first sales price of the source code stored in the storage device corresponding to the information for specifying the fourth source code based on the evaluation of the content of the article information so as to calculate the second sales price.

25. The method for trading source code of claim 21, further comprising:
calculating a use rate of a similar source code to a new source code in a case where the similar source code, which is similar to the new source code is stored in the storage device, and
determining a distribution rate of the sales price of the new source code based on the use rate.

26. The method for trading source code of claim 25, wherein the distribution rate of the sales price to the new source code is increased in a case where the similar source code similar to the new source code is stored in the storage device and a reference information to the similar source code is described in the new source code.

27. (canceled)
